(19) United States
(12) Patent Application Publication
(10) Pub. No.: US 2007/0182254 A1
(43) Pub. Date: Aug. 9, 2007

(54) Combination type of socket with power source management

(76) Inventor: Yu-Chung Lee, Taipei (TW)

Correspondence Address: LEONG C LEI, PMB # 1008, 1867 YGNACIO VALLEY ROAD, WALNUT CREEK, CA, 94598, US

(21) Appl. No.: 09/777,827

(22) Filed: Feb. 7, 2001

(51) Int. Cl. H02B 1/24

(52) U.S. Cl. 307/116

(57) ABSTRACT

A combination type of socket with power source management which includes a power source protection and filter body, a multi-hole outlet extension socket body, an automatic timing socket body, a synchronized main/secondary socket body, a main plug provided to the power source protection and filter body for connection to a common power source having a power source switch and a socket for connection with extension outlet socket. The socket is characterized in that the power source protection and filter body is provided with a power source quality processing circuit, excess voltage input prevention circuit, low high current indication alarm circuit, low high voltage indication alarm circuit, control circuit for voltage, and current indicator such that after the power source is input, noise elimination, surge absorption treatment, input voltage, and current value are monitored and indicated and the current is cut off at abnormal or warning alarm is produced.

### BACKGROUND OF THE INVENTION

(a) Field of the Invention

The present invention relates to a combination type of socket having a plurality of holes for the connection to other external electrical load and to provide voltage control, mounting and cutting off of abnormal current supply.

(b) Description of the Prior Art

Conventional type of socket for extension is normally an elongated socket body having a plurality of sockets being provided with fuse, power source switches and the functions of such type of socket are as follows:

(1) providing a multiple distribution of power source;

(2) manually controlling the electrical communication or cutting off of power supply; and

(3) cutting off of current supply at excessive load to prevent short-circuited. In view of the above, it is understood that the conventional socket seat is merely functioned as a connection of power source without additional functions such as power source filter, surge absorption, noise reduction, abnormal current indication and warning, low/high voltage indication, timing for load, etc.

Accordingly, it is an object of the present invention to provide a combination type of socket with power source management which mitigates the above drawbacks.

### SUMMARY OF THE INVENTION

An object of the present invention is to provide a combination type of socket with power source management, comprising power source protection and filter body, multi hole output extension socket body, automatic timing socket body, synchronized main/secondary socket body, and the individual socket bodies are provided with plug and can be mounted to each other as a unit.

Yet another object of the present invention is to provide a combination type of socket with power source management, comprising a control circuit including a filter, surge absorption and noise reduction treating circuit, high/low current indicating/alarming circuit, high/low voltage indicating/alarming circuit, temperature fuse, excess voltage input prevention circuit, and with power source quality management and control functions.

Yet a further object of the invention is to provide a combination type of socket with power source management, wherein the multi hole output extension socket body is provided with a plurality of socket.

A further object of the invention is to provide a combination type of socket with power source management, further comprising circuit inspection circuit, amplification driving circuit, control circuit of clock/timing circuit such that when a load is connected, automatic recordation of time utilization is activated.

A further object of the invention is to provide a combination type of socket with power source management, wherein the synchronized main/secondary socket body is provided with current inspection circuit, relays such that when the load of the main socket is activated or stopped, the secondary socket is also simultaneously activated or stopped.

Other objects, and advantages of the present invention can be more fully understood by reading the following detailed description of the preferred embodiment, with reference to the accompanying.

### BRIEF DESCRIPTION OF THE DRAWINGS

FIG. 1 is a perspective view of the present invention.

FIG. 2A is a control circuit diagram of the power source protection and the filter body of the present invention.

FIG. 2B is a control block diagram of the power source protection and the filter body of the present invention.

FIG. 3A is a control circuit diagram of the automatic timing socket of the present invention.

FIG. 3B is a control block diagram of the automatic timing socket of the present invention.

FIG. 4A is a control circuit diagram of the synchronized main/secondary socket of the present invention.

FIG. 4B is a control block diagram of the synchronized main/secondary socket of the present invention.

### DETAILED DESCRIPTION OF THE PRESENT INVENTION

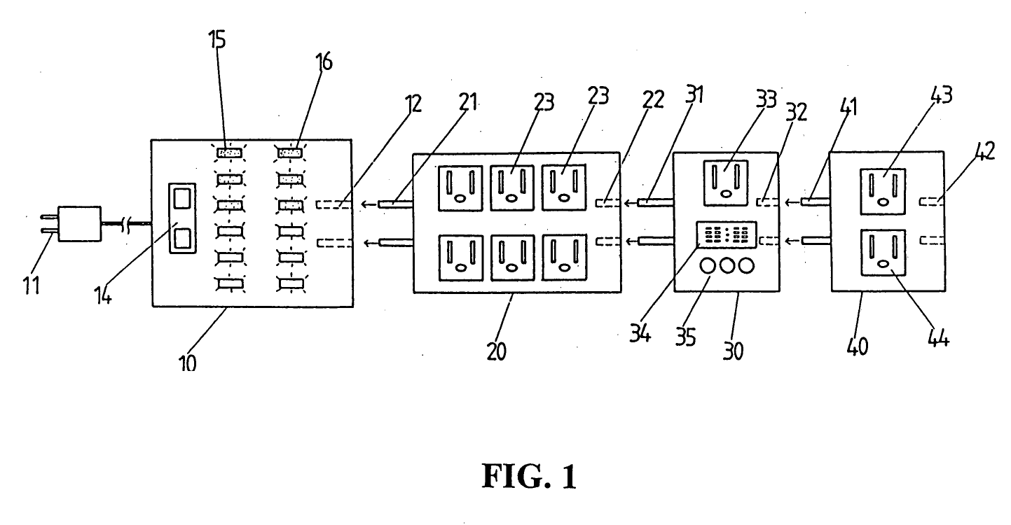

Referring to FIGS. 1, 2A, 3A and 4A, there is shown a combination type of socket with power source management comprising a power source protection and filter body 10, a multi hole outlet extension socket body 20, an automatic timing socket body 30, and a synchronized main/secondary socket body 40. The power source protection and filter body 10 is provided with a main plug 11 for connection to a common power source and a power source switch 14, a temperature fuse FS and a socket 12 having extension outlet and for connection with other socket body. The socket body 20, 30, 40 are provided with input plug 21, 31, 41 and extension outlet socket 22, 32 and 42 for mutual plugging connection.

The power source protection and filter body 10 is provided with a power source quality processing circuit 101, excess voltage input-prevention circuit 102, low high current indication alarm circuit 103, low high voltage indication alarm circuit 104, and control circuit for voltage, current indicator 15, 16 such that after the power source is input, it is filtered, noise elimination, surge absorption treatment and the input voltage, current value are monitored and indicated and the current is cut off at abnormal or warning alarm is produced.

A normal close point b of a relay R21 is connected in serial between the excess voltage input prevention circuit 102 of the power source protection and filter body 10, and the processing circuit 101, under normal condition, the normal close point b remains conductive to current and under abnormal condition, it is cut off, the alarm circuit 103 is provided with a current comparator CT to inspect the current size of the circuit, and a relay RL2 is connected in parallel to the processing circuit 101, under abnormal current condition, the relay RL2 is cut off and the buzzer B2 produces an alarming sound. The multi outlet extension socket body 20 is provided with a plurality of sockets 23 for external load of other appliance. The automatic timing socket body 30 is provided with an automatic timing socket 33 and a normal open point a of a relay RL3 connected in series, and a current inspection circuit 301, an amplification driving circuit 302, and a clock/timing circuit 303 with setting button 35 and timing display 34, and before the timing output socket 33 is mounted with a load, the timing display 34 indicates time function, and after the timing output socket 33 is mounted with a load, the timing function is automatically activated and the application time of load is recorded.

A current comparator CT is provided on the current inspection circuit 301 of the automatic timing socket body 30 to inspect current and is connected in series with the amplification driving circuit 302 and is input with a clock/timing circuit 303, and the clock/timing circuit 303 is provided with a relay RL3 connected in series with the normal open point a circuit and, when the timing output socket 33 is mounted with a load, the relay RL3 is electrically connected and the current comparator CT senses the current passage to the load and is then input to the clock/timing circuit 303 and the application time is totaled and displayed on timing display 34.

The synchronized main/secondary socket body 40 is provided with a main, a secondary output socket 43, 44, and the main output socket 43 is directly connected in parallel to the circuit, the secondary output socket 44 is connected in series to the normal open point a of the relay RL4, and is provided with a current inspection circuit 401, an amplification driving circuit 402, and the main and the secondary output socket 43, 44 are synchronized when the main output socket 43 is cut off, the secondary output socket 44 is also cut off.

The circuit of the main output socket 43 is connected to the current comparator CT mounted with a current inspection circuit 401 and is then connected to the amplification driving circuit 402 and the amplification driving circuit 402 is provided with a relay RL4, the normal open point a of the relay RL4 is connected in series to the circuit, thus, when a load is connected to the main outlet socket 43 to generate current, the current inspection circuit 401 detects the current and the amplification driving circuit 402 is initiated, i.e., the relay RL4 is electrically connected and the secondary output socket 44 is provided with current, on the contrary, if the load is not applied, the relay RL4 will not provide current to the secondary output socket 44.

In accordance with the present invention, in application, the power source protection and filter body 10, multi hole outlet extension socket 20, automatic timing socket body 30, synchronized main/secondary socket body 40, are mounted to each other to form an integral unit. Also, the individual socket body can individually plug onto a general socket.

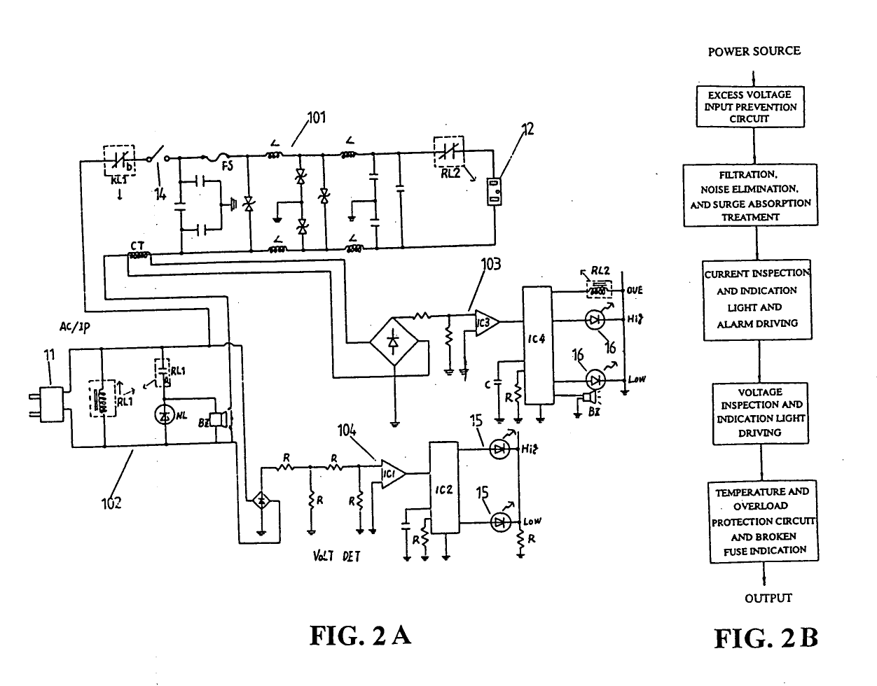

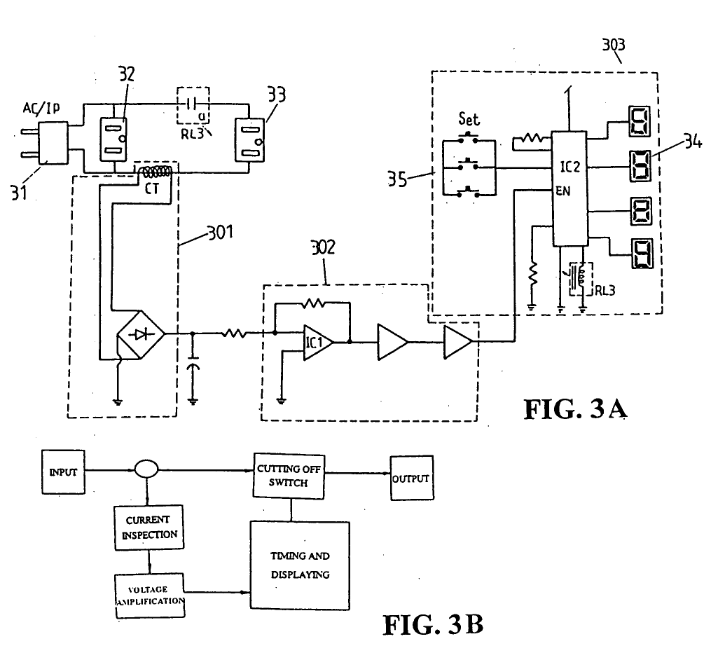

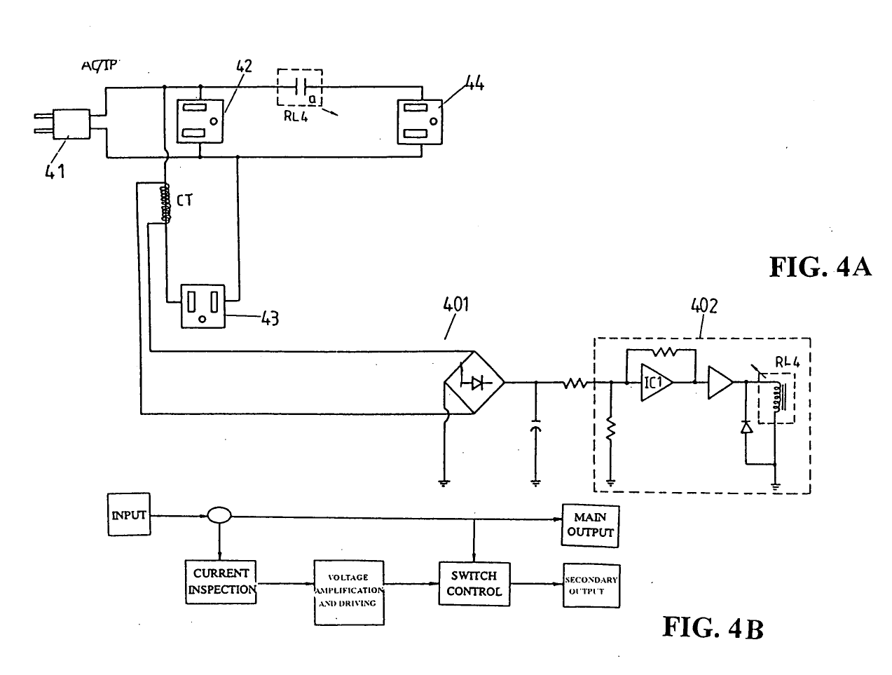

In accordance with the present invention, the control and advantages of the individual socket body are as follows:
(1) Power source protection and filter body 10: Referring to FIGS. 2A, 2B, the power source enters through the excess voltage input-prevention circuit 102 and is connected in series to the normal closed point b of a relay RL1, and in combination with the current comparator IC1 and the monitoring control of Integrated Circuit IC₂. The voltage display device 15 indicates the voltage condition, and if it exceeds the preset value, the relay RL1 will cut off and the normal closed point b becomes the state of normal opened, and the current is cut off, and the normal open point a of the relay RL1 will become open, and the buzzer B2 will produce an alarm sound. The input power source is filtered by a power source quality processing circuit 101 to eliminate noise and surge such that the power source has a better quality. In addition, the current comparator CT can detect the current in the circuit and after the monitoring control of the integrated circuit IC3, IC4, the current indicator 16 indicates the present status. If it exceeds the preset value, the other relay RL2 will cut off, and the buzzer B2 will produce an alarming sound.
(2) Automatic timing socket body 30. Referring to FIGS. 3A, 3B, when the output socket 33 does not connect with a load, the inspection circuit 301 detects no current (RL3 being cut off), and the display 34 of the clock/timing circuit 303 displays the time. When a load is connected, the circuit 301 will detect a change of current value and the relay RL3 of the clock/timing circuit 303 is triggered, and the normal open point a is closed to provide power source to the load, and the current comparator CT detects the current, i.e., the clock/timing circuit 303 provides the timing function and the time utilized by the load is totaled. Also, the preset button 35 can use to set the require time.
(3) Synchronized main/secondary socket body 40. Referring to FIGS. 4A and 4B, when the main output socket 43 does not connect with load, or the load is not operating (being opened circuit), the comparator CT detects no current and the relay RL4 of the amplification driving circuit 402 will not have any action. The normal opened point a is not in communication and the secondary output socket 44 is an opened circuit. When a load is connected to the main output socket 43, the comparator CT will detect the current and via the amplification driving circuit 402, the relay RL4 is triggered, and the normal opened point a is closed for communication and power source is provided to the secondary output socket 44. In view of the above, the power source of the secondary output socket 44 is dependent on the application of load and the communication of load.

In accordance with the present invention, the present device can be used on a host computer and other peripherals as follows:
(1) The power source protection and filter body 10 provides power source with low noise and surge will allow more stable function for the host computer and other peripherals. Any abnormal voltage or current, the current is automatic cut off and the computer is thus protected and an alarming sound is produced to warn the user to stop using the computer.
(2) Multi hole output extension socket 20 may not be used or used with other electrical load.
(3) Automatic timing socket body 30 can calculate the total time of utilizing the computer.
(4) The synchronized main/secondary socket body 40 allows simultaneous cut off of power source supply to other peripheral.

Although the preferred embodiment of the invention is described hereinabove, it should be clear that any number of alterations could be made thereto without departing from the scope of the invention is claimed.

I claim:

1. A combination type of socket with power source management comprising a power source protection and filter body, a multi hole outlet extension socket body, an automatic timing socket body, a synchronized main/secondary socket body, a main plug being provided to the power source protection and filter body for connection be a common power source having a power source switch and a socket for connection with extension outlet socket, characterized in that the power source protection and filter body is provided with a power source quality processing circuit, excess voltage input-prevention circuit, low high current indication alarm circuit, low high voltage indication alarm circuit, and control circuit for voltage, current indicator such that after the power source is input, it is filtered, noise elimination, surge absorption treatment and the input voltage, current value are monitored and indicated and the current is cut off at abnormal or warning alarm is produced; the power source protection and filter body is provided with a power source quality processing circuit, excess voltage input-prevention circuit, low high current indication alarm circuit, low high voltage indication alarm circuit, and control circuit for voltage, current indicator such that after the power source is input, it is filtered, noise elimination, surge absorption treatment and the input voltage, current value are monitored and indicated and the current is cut off at abnormal or warning alarm is produced; the automatic timing socket body is provided with an automatic timing socket and a normal open point a of a relay RL3 connected in series, and a current inspection circuit, an amplification driving circuit, and a clock/timing circuit with setting button and timing display, and before the timing output socket is mounted with a load, the timing display indicates time function, and after the timing output socket is mounted with a load, the timing function is automatically activated and the application time of load is recorded; the synchronized main/secondary socket body is provided with a main, a secondary output socket and the main output socket is directly connected in parallel to the circuit, the secondary output socket is connected in series to the normal open point a of the relay RL4, and is provided with a current inspection circuit, an amplification driving circuit, and the main and the secondary output socket are synchronized when the main output socket is cut off, the secondary output socket is also cut off.

2. A combination type of socket as set forth in claim 1, wherein in between the excess voltage input prevention circuit and the power source quality processing circuit, a normal opened point of a relay is connected in series.

3. A combination type of socket as set forth in claim 1, wherein the multi hole output extension socket body is provided with a plurality of output sockets for external connection of electrical loads.

4. A combination type of socket as set forth in claim 1, wherein on the current inspection circuit, a current comparator is provided to inspect current and is connected in series with an amplification driving circuit and is then extended with clock/timing circuit, and the clock/timing circuit is provided with relay which is connected in series to the normal opened point of the circuit.

5. A combination type of socket as set forth in claim 1, wherein the main output socket circuit is connected with a current comparator having a current inspection circuit, and is the connected to the application driving circuit.
